(19) United States
(12) Patent Application Publication
(10) Pub. No.: US 2007/0072062 A1
(43) Pub. Date: Mar. 29, 2007

(54) Lithium secondary battery and method of manufacturing the same

(75) Inventors: Atsushi Fukui, Kobe-shi (JP); Hiroshi Minami, Kobe-shi (JP); Yasuyuki Kusumoto, Kobe-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/526,770

(22) Filed: Sep. 26, 2006

(30) Foreign Application Priority Data
Sep. 26, 2005 (JP) 2005-277128

(51) Int. Cl. H01M 4/02; H01M 4/58; H01M 2/26; H01M 10/04

(52) U.S. Cl. 429/94; 429/218.1; 429/161; 429/211; 29/623.1

(57) ABSTRACT

A lithium secondary battery is provided in which the current collector tab attachment structure has been improved to inhibit a drop in the charge-discharge cycle performance while inhibiting bulging in the battery, thereby allowing the volume energy density to be increased. The positive electrode current collector at the outermost periphery portion of a flat electrode assembly is provided with a positive electrode current collector tab that is parallel to the winding direction of the flat electrode assembly, and the negative electrode current collector at the outermost periphery portion of the flat electrode assembly is provided with a negative electrode current collector tab that is parallel to the winding direction of the flat electrode assembly.

### BACKGROUND OF THE INVENTION

1. Field of the Invention

The present invention relates to lithium secondary batteries and methods of manufacturing the same, and more particularly to improvements to the current collector tabs used in lithium secondary batteries.

2. Description of Related Art

Mobile information terminals such as portable telephones, notebook computers, and PDAs have become smaller and lighter at a rapid pace in recent years, and this has led to a demand for higher capacity batteries as the drive power source for these mobile information terminals. Lithium secondary batteries are charged and discharged through the transfer of lithium ions between the positive and negative electrodes, and have a high energy density and are high capacity, and thus are widely used as the drive power source of such mobile information terminals. As mobile information terminals become even smaller and higher performance in the future, it is foreseeable that a greater burden will be placed on the lithium secondary battery power source, and for this reason, there is a pronounced demand for secondary lithium batteries with higher energy densities.

An effective means for increasing the energy density of a battery is to use a material that has a larger energy density as the active material. Recently there have been proposals and investigations into the use, in lithium secondary batteries, of aluminum, tin, or silicon that is capable of intercalating lithium in an alloying reaction with lithium as a negative electrode active material that has a higher energy density, in lieu of carbon material such as graphite, which currently is used.

When a material alloyed with lithium is used as the negative electrode active material of a lithium secondary battery, however, sudden changes in volume due to the expansion and shrinkage of the negative electrode active material during charging and discharging pulverize the negative electrode active material and cause it to peel off from the current collector as the charge-discharge cycle progresses. As a result, the current collection performance in the electrode drops, and the charge-discharge cycle performance becomes poor.

In view of the problem, it has been proposed that in a negative electrode that uses a material that contains silicon as the negative electrode active material to alloy with lithium, a negative electrode that is obtained by forming a negative electrode active material thin film layer made of a material containing silicon (JP 2002-83594A), or by sintering a negative electrode mixture layer containing a binder and a negative electrode active material made from a material containing silicon in a non-oxidizing atmosphere (JP 2002-260637A), on the surface of a negative electrode current collector that is made of a conductive metal foil and that includes surface irregularities demonstrates excellent current collection performance in the electrode due to the high adhesion between the negative electrode mixture layer and the negative electrode current collector, and can obtain good charge-discharge cycle performance.

To achieve higher energy density in a battery, it is necessary to not only employ an active material that has a high energy density such as that as discussed above, but also to pack as much positive electrode active material and negative electrode active material as possible into a battery case of a determined size. In commonly used batteries, high energy density is achieved by winding an electrode assembly in which the positive electrode and the negative electrode oppose each other across a separator into a flat or a cylindrical form, and accommodating the electrode assembly in a square or a cylindrical container.

When a material that contains silicon is used for the negative electrode active material, however, particularly in an electrode in which good charge-discharge cycle performance is obtained due to the tight binding between the above negative electrode mixture layer and the negative electrode current collector, there is the problem that the large change in active material volume that occurs when lithium is occluded and released causes the electrode assembly in flat batteries to deform (bend), and this increases the thickness of the electrode assembly, and therefore the volume energy density of the battery drops. This is described in more specific detail using FIGS. 17 to 20.

As shown in FIGS. 17 and 18, the flat battery has a spirally-wound flat electrode assembly 60 that is made of a positive electrode 51, a negative electrode 52, and a separator 53 provided between the positive and negative electrodes, and the spirally-wound flat electrode assembly 60 is disposed in the accommodation space of a battery case 56. The positive electrode 51 and the negative electrode 52 are connected to a positive electrode current collector tab 54 and to a negative electrode current collector tab 55, respectively, that can extend outside the battery case 56, thus achieving a structure that is capable of charging and discharging as a secondary battery. It should be noted that in both drawings, reference numeral 57 denotes a heat seal portion. In FIG. 18, the H direction is the width direction, and the J direction is the thickness direction.

In a flat battery with this structure, the thickness of a bent portion 58 of the flat electrode assembly 60 increases also, because the negative electrode mixture layer expands in volume the due to charging. On the other hand, it can be understood from FIG. 18 that very little space, if any at all, exists between the bent portion 58 and the battery case 56, and thus, in the flat battery, the width direction H of the flat electrode assembly 60 is restricted by the battery case 56. Consequently, when the negative electrode mixture layer expands in volume at the bent portion 58 and the thickness of the bent portion 58 increases, the amount by which it increases tries to escape in the width direction H of the flat electrode assembly 60 (specifically, in FIG. 18 both bent portions 58 of the flat electrode assembly 60 try to bulge toward the center of the flat electrode assembly 60). The result is that the planar portion of the flat electrode assembly 60 bends in waves that are parallel to the winding direction as shown in FIG. 19, and this increases the size of the flat electrode assembly 60 in the thickness direction J.

In addition, in conventional batteries, the positive electrode current collector tab 54 and the negative electrode current collector tab 55 are formed perpendicular to the winding direction of the flat electrode assembly 60, and when the negative electrode mixture layer expands in volume and both bent portions 58 of the flat electrode assembly 60 try to bulge toward the center of the flat electrode assembly 60 as discussed above, the current collector tabs 54 and 55 present inside the battery are deformed toward the center of the flat electrode assembly 60 as shown in FIG. 20 because they are fastened by the heat seal portion 57. A stress thus acts on both current collector tabs 54 and 55, and a twisting force acts on the collector tabs 54 and 55 in order to relieve this stress. The result is that waves occur in the flat electrode assembly 60 along both current collector tabs 54 and 55 as shown in FIG. 19, and this further exacerbates bending in the flat electrode assembly 60.

### BRIEF SUMMARY OF THE INVENTION

Accordingly, it is a primary object of the invention to provide a lithium secondary battery in which improvements have been made to the structure of the flat electrode assembly, and in particular to the structure for attaching the current collector tabs, so as to inhibit a drop in charge-discharge cycle performance while inhibiting bulging in the battery, thereby allowing the volume energy density to be increased.

In order to accomplish the foregoing and other objects, the present invention provides a lithium secondary battery comprising: a sheet-shaped positive electrode in which a positive electrode mixture layer containing a positive electrode active material is disposed on a surface of a positive electrode current collector made from a conductive metal foil; a sheet-shaped negative electrode in which a negative electrode mixture layer containing negative electrode active material particles and a negative electrode binder for binding the negative electrode active material particles to one another is disposed on a surface of a negative electrode current collector made from a conductive metal foil; a sheet-shaped separator that is disposed between the positive electrode and the negative electrode; a non-aqueous electrolyte; and a battery case accommodating a flat electrode assembly in which the positive electrode and the negative electrode are wound in a state where they are in opposition to one another across the separator, wherein: the negative electrode active material contains silicon; and at least one of the current collectors, of the positive electrode current collector at the outermost periphery portion of the flat electrode assembly and the negative electrode current collector at the outermost periphery portion of the flat electrode assembly, is provided with a current collector tab that is parallel to the winding direction of the flat electrode assembly.

With this configuration, if at least one of the current collectors at the outermost periphery portion of the flat electrode assembly is provided with a current collector tab that is parallel to the winding direction of the flat electrode assembly, then it is possible to prevent the current collector tabs that are provided parallel to the winding direction and that are present inside the battery from deforming toward the center of the flat electrode assembly, even if the negative electrode mixture layer expands in volume and causes both bent portions of the flat electrode assembly to bulge toward the center of the flat electrode assembly. Thus, since there is no attempt by the current collector tabs to twist, it is possible to inhibit the bending of the flat electrode assembly that is exacerbated due to the presence of the current collector tabs. Consequently, bulging of the battery is inhibited.

When the negative electrode active material contains silicon as with this configuration, the change in volume of the negative electrode active material that accompanies lithium occlusion and release becomes quite large and thus bulging of the battery is further inhibited by adopting this structure of the invention.

Here, what is meant by the negative electrode active material containing silicon is that the negative electrode active material is constituted by particles that contain silicon and/or a silicon alloy, and examples of the silicon alloy include solid solutions of silicon and at least one other element, intermetallic compounds of silicon and at least one other element, and eutectic alloys of silicon and at least one other element.

Examples of methods for fabricating such alloys include arc melting, liquid quenching techniques, mechanical alloying, sputtering, chemical vapor deposition, and sintering. In particular, examples of liquid quenching techniques include single-roll quenching, double-roller quenching, and various atomization techniques such as gas atomization, water atomization, and disk atomization.

As the negative electrode active material particles in the lithium secondary battery of the invention, it is possible to use particles that are obtained by coating the surface of particles that contain silicon and/or silicon alloys with metal or the like. Examples of coating methods include electroless plating, electroplating, chemical reduction techniques, evaporation, sputtering, and chemical vapor deposition.

It should be noted that the negative electrode active material of the invention is not limited to silicon, and naturally it is also possible to adopt an element with which the volume of the negative electrode active material changes in conjunction with the occlusion and release of lithium, such as aluminum, germanium, zinc, magnesium, sodium, potassium, indium, or tin.

It is desirable that the positive electrode current collector and the negative electrode current collector both be provided with a current collector tab that is provided parallel to the winding direction of the flat electrode assembly.

By providing two current collector tabs that are parallel to the winding direction of the flat electrode assembly, neither of the two current collector tabs attempts to twist, and thus the presence of the current collector tabs can further inhibit bending of the flat electrode assembly from being facilitated.

The negative electrode mixture layer is characterized in that it is disposed sintered on the surface of the negative electrode current collector.

Although silicon allows greater lithium occlusion than graphite material, it accompanies larger volume expansion than graphite material. However, with the above configuration, sintering has the effect of significantly increasing the tightness of the bond between negative electrode active material particles and the tightness of the bond between the negative electrode mixture layer and the negative electrode current collector, and thus high current collection performance is attained in the negative electrode. As a result, it is possible to obtain a battery that has a high energy density and has excellent charge-discharge cycle performance.

It is desirable that a positive electrode current collector tab that is separate from the positive electrode current collector is attached to the positive electrode current collector, and a negative electrode current collector tab that is separate from the negative electrode current collector is attached to the negative electrode current collector.

With this configuration, the mechanical strength of the current collector tabs that results from attaching a current collector tab that is separate from the current collector to each of the current collectors (as opposed to when the current collector tabs are bent up using a portion of both current collectors), and coupled with the fact that these current collector tabs are attached parallel to the winding direction of the flat electrode assembly, has the effect of suppressing the wavelike bending of the electrode assembly that occurs during charging and discharging. Thus, bending of the flat electrode assembly can be suppressed further.

It should be noted that as the method for attaching the two current collector tabs to the two current collectors, it is preferable that ultrasonic welding or a piercing method be used. This is because these methods are simple and sufficiently tight binding can be retained.

It is desirable that the positive electrode current collector tab is made from a flat aluminum sheet, and the negative electrode current collector tab is made from a flat nickel sheet.

Restricting the material of the current collector tabs in this way by using these materials has the effect that lithium occlusion and release do not occur in the current collector tabs when charging and discharging, and the current collector tabs do not dissolve into the non-aqueous electrolyte, and thus the current collector tabs can stably exist in the battery.

It is desirable that the aluminum sheet and the nickel sheet be both at least 50 μm thick but not more than 100 μm thick.

The reason for restricting the configuration in this way is that when the thickness of the aluminum sheet, for example, is less than 50 μm thick, the mechanical strength of the aluminum sheet, for example, does not become large, and thus it may not be possible to sufficiently attain the effect of inhibiting bending in the flat electrode assembly, whereas when the thickness of the aluminum sheet, for example, is greater than 100 μm thick, the amount by which the thickness of the flat electrode assembly increases also becomes large, and thus it is not possible to further increase the energy density of the battery.

It is desirable that the proportion of the attached area of the positive electrode current collector tab with respect to the electrode area of the planar portion of the positive electrode that is located at the outermost periphery of the flat electrode assembly, and/or a proportion of the attached area of the negative electrode current collector tab with respect to the electrode area of the planar portion of the negative electrode that is located at the outermost periphery of the flat electrode assembly, be regulated so that it is 5% or more.

With this configuration, regulating the proportion of the attached area of at least one of the two current collector tabs increases the mechanical strength of the current collector tabs if the attached area of the current collector tabs is large, and thus the effect of inhibiting bending of the flat electrode assembly increases and a battery with a higher energy density can be obtained.

Another aspect of the invention for achieving the foregoing and other objects is characterized by including fabricating a positive electrode by disposing a positive electrode mixture layer containing positive electrode active material particles and a positive electrode binder on a surface of a positive electrode current collector made from a sheet-shaped conductive metal foil, and fabricating a negative electrode by disposing a negative electrode mixture layer containing negative electrode active material particles and a negative electrode binder on a surface of a negative electrode current collector made from a sheet-shaped conductive metal foil, forming a positive electrode current collector tab, made of a metal material, near one end portion of the positive electrode and parallel to a lengthwise direction of the positive electrode, and forming a negative electrode current collector tab, made of a metal material, near one end portion of the negative electrode and parallel to a lengthwise direction of the negative electrode, winding the two electrodes parallel to the direction in which the current collector tabs are attached, the positive electrode and the negative electrode in opposition to one another across a separator, to fabricate a flat electrode assembly in which the two current collector tabs are exposed from the outermost periphery, and accommodating the flat electrode assembly in a battery case and injecting an electrolyte solution into this battery case.

With this method, it is possible to fabricate the lithium secondary battery described above smoothly.

It is desirable that the negative electrode active material contains silicon, and when fabricating the negative electrode in the step of fabricating the positive and negative electrodes, the negative electrode mixture layer containing negative electrode active material particles and a negative electrode binder is sintered on the surface of the negative electrode current collector.

With this method, it is possible to fabricate the lithium secondary battery described above smoothly.

In this case, one specific example of the manufacturing method is a method in which negative electrode active material particles are evenly mixed and dispersed in the negative electrode binder solution to produce a slurry that is then applied onto the surface of a negative electrode current collector, made of a conductive metal film, to dispose a negative electrode mixture layer, and with the negative electrode mixture layer disposed on the surface of the negative electrode current collector, the negative electrode mixture layer is sintered in a non-oxidizing atmosphere.

Examples of a non-oxidizing atmosphere include a vacuum, a nitrogen atmosphere, an inert gas atmosphere such as argon, or a reducing atmosphere such as a hydrogen atmosphere. It is preferable that the temperature of the thermal processing when sintering be less than the melting point of the negative electrode active material and the negative electrode current collector, which is made of a conductive metal foil. For example, if copper foil is used as the negative electrode current collector, then preferably the temperature is below copper's melting point of 1083° C. Also, since, as discussed above, it is also preferable that the thermal processing for sintering be conducted at a temperature at which the negative electrode binder does not completely decompose in order to increase the current collection performance of the negative electrode, it is further preferable that the temperature be between 200° C. and 500° C., and even more preferably between 300° C. and 450° C. It is also possible to conduct sintering of the negative electrode in an oxidizing atmosphere such as air, but in this case, the temperature of the thermal processing for the sintering preferably is not more than 300° C. As the sintering method, it is further possible to use a discharge plasma sintering technique or hot pressing.

In the negative electrode of the lithium secondary battery of the invention, it is also preferable that the after the negative electrode mixture layer has been formed on the negative electrode current collector, the negative electrode mixture layer be pressure-rolled together with the negative electrode current collector before it is sintered. Due to this pressure-rolling, it is possible to increase the filling density of the negative electrode mixture layer, and thus the thickness of the negative electrode mixture layer can be reduced and the closeness of the bond between the negative electrode active material particles and between the negative electrode mixture layer and the negative electrode current collector can be increased, and as a result, it is possible to obtain a battery with high energy density and with excellent charge-discharge cycle performance.

As illustrated above, the present invention attains the excellent effect of inhibiting a drop in the charge-discharge cycle performance while dramatically increasing the volume energy density of the lithium secondary battery.

### BRIEF DESCRIPTION OF THE DRAWINGS

FIG. 1 is a front view of the lithium secondary battery according to the invention;

FIG. 2 is a cross-section taken along the line A-A in FIG. 1 (before charging);

FIG. 3 is a front view of the positive electrode (before winding) that is used in the lithium secondary battery of Example 1;

FIG. 4 is a front view of the negative electrode (before winding) that is used in the lithium secondary battery of Example 1;

FIG. 5 is a front view of the flat electrode assembly (before winding) that is used in the lithium secondary battery of Example 1;

FIG. 6 is a front view of the positive electrode (before winding) that is used in the lithium secondary battery of Example 2;

FIG. 7 is a front view of the negative electrode (before winding) that is used in the lithium secondary battery of Example 2;

FIG. 8 is a front view of the flat electrode assembly (before winding) that is used in the lithium secondary battery of Example 2;

FIG. 9 is a front view of the positive electrode (before winding) that is used in the lithium secondary battery of Comparative Example 1;

FIG. 10 is a front view of the negative electrode (before winding) that is used in the lithium secondary battery of Comparative Example 1;

FIG. 11 is a front view of the flat electrode assembly (before winding) that is used in the lithium secondary battery of Comparative Example 1;

FIG. 12 is a front view of the positive electrode (before winding) that is used in the lithium secondary battery of Comparative Example 2;

FIG. 13 is a front view of the negative electrode (before winding) that is used in the lithium secondary battery of Comparative Example 2;

FIG. 14 is a front view of the flat electrode assembly (before winding) that is used in the lithium secondary battery of Comparative Example 2;

FIG. 15 is a cross-section taken along the line A-A in FIG. 1 (after charging);

FIG. 16 is a front view of a modified example of the invention;

FIG. 17 is a front view of the lithium secondary battery according to the conventional example;

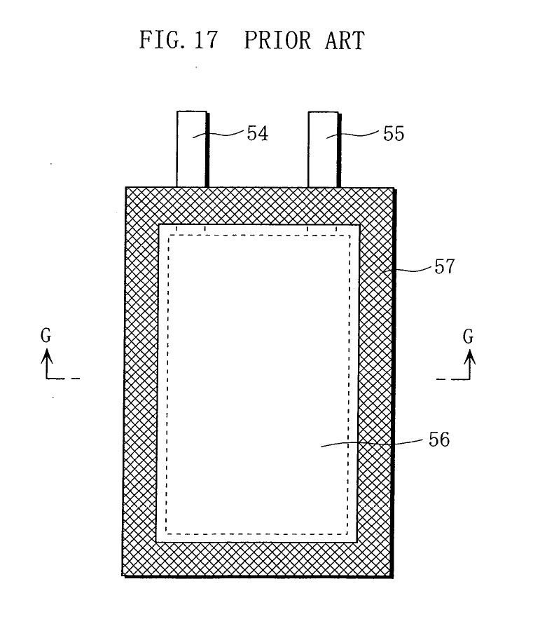

FIG. 18 is a cross-section taken along the line G-G in FIG. 17 (before charging);

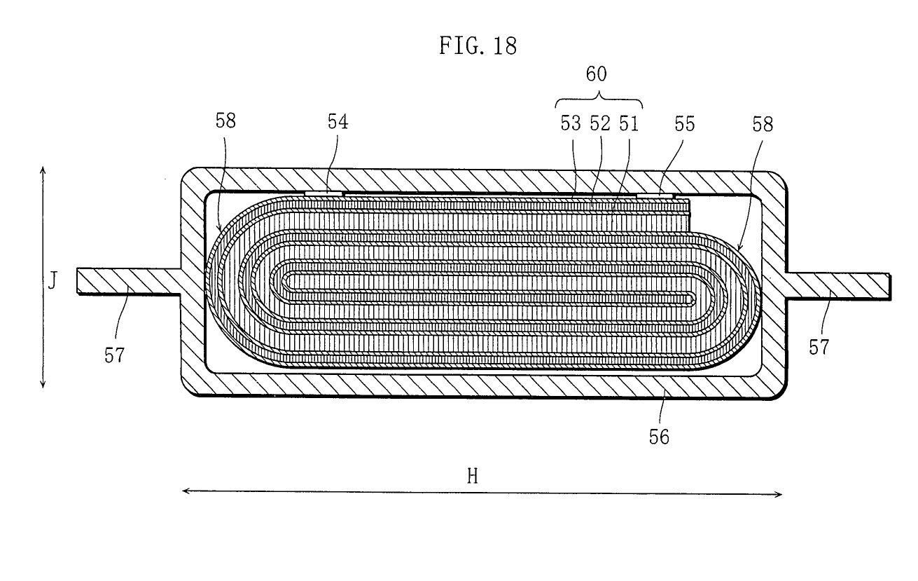

FIG. 19 is a cross-section taken along the line G-G in FIG. 17 (after charging); and

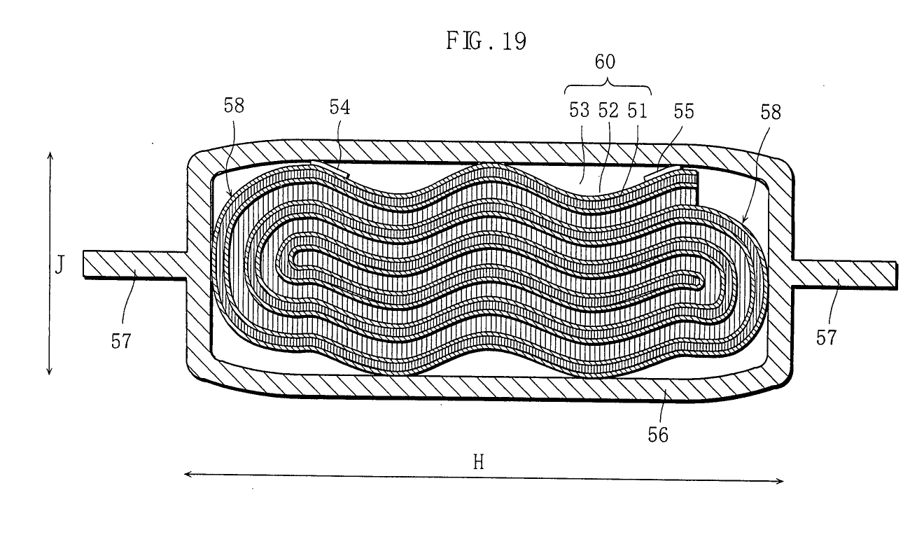

FIG. 20 is an explanatory diagram showing the state near the current collector tabs during charge.

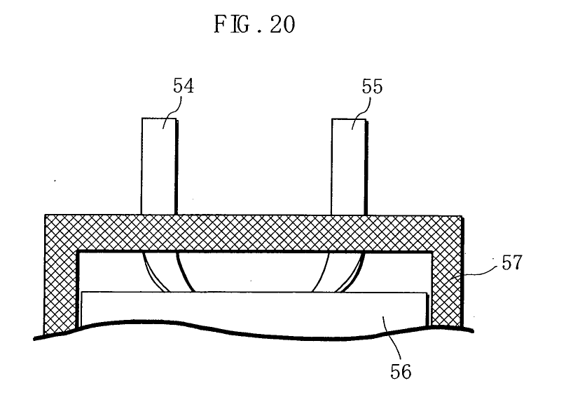

### DETAILED DESCRIPTION OF THE INVENTION

Hereinbelow, the present invention is described in further detail based on preferred embodiments thereof. It should be construed, however, that the present invention is not limited to the following preferred embodiments but various changes and modifications are possible without departing from the scope of the invention.

### EXAMPLE 1

### Preparation of Positive Electrode

First, Li₂CO₃ and CoCO₃ were used as the starting material, and the two were weighed to an atomic ratio Li:Co of 1:1, mixed by mortar, and then sintered for 24 hours at 800° C. in an air atmosphere to obtain a sintered lithium-cobalt composite oxide (lithium-transition metal composite oxide) represented by LiCoO₂. The sintered member was then pulverized in a mortar to produce particles with an average particle size of approximately 7 μm. It should be noted that the BET specific surface area of the LiCoO₂ powder was 0.49 m²/g.

Next, the LiCoO₂ powder, serving as a positive electrode active material, a carbon material powder serving as a positive electrode conductive agent, and polyvinylidene fluoride serving as a positive electrode binder were added to a dispersion medium of N-methyl-2-pyrrolidone, and these were then kneaded to produce a positive electrode mixture slurry. It should be noted that the mass ratio of the LiCoO₂ powder, the carbon material powder, and the polyvinylidene fluoride was 94:3:3.

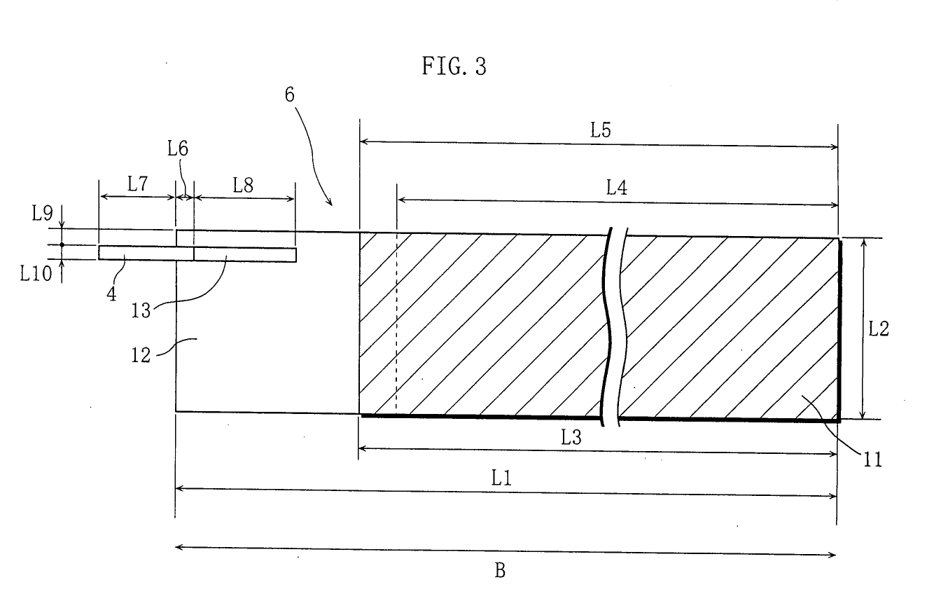

As shown in FIG. 3, this positive electrode mixture slurry was then applied to and dried on both sides of an aluminum foil (length L1 377 mm, width L2 50 mm, thickness 15 μm) serving as a positive electrode current collector, and then pressure-rolling was performed to form a positive electrode mixture layer 11. It should be noted that the length L5 of the front surface side of the positive electrode mixture layer 11 was 340 mm and the length L4 of its rear surface side was 270 mm (since both lengths L4 and L5 of the positive electrode mixture layer 11 are shorter than the length L1 of the aluminum foil, a positive electrode current collector exposed portion 12 is formed at the end portion of the aluminum foil). The amount of positive electrode mixture layer formed on the positive electrode current collector was 53 mg/cm².

Lastly, a lengthwise long cut (width L10: 4 mm, length L8: 15 mm) was provided in the positive electrode current collector exposed portion 12 (later, the positive electrode current collector exposed portion 12 located at the outermost periphery of the spirally-wound electrode assembly) from a position a distance L6 of 5 mm from the left end and a distance L9 of 3 mm from the upper end in such a manner that it is parallel to the winding direction B and toward the positive electrode mixture layer 11. This cut was then bent up to form a positive electrode current collector tab 4. It should be noted that along with this, a long hole 13 is formed in the positive electrode current collector exposed portion 12. The length L7 of the positive electrode current collector tab 4 that protrudes from the end portion of the positive electrode is expressed by the length L8 of the cut minus the distance L6 from the left end, and thus is 10 mm.

### Preparation of Negative Electrode

First, silicon powder (average particle size 5.5 μm, purity 99.9%) serving as a negative electrode active material, and a thermoplastic polyimide (glass transition temperature 190° C., density 1.1 g/cm³) serving as a negative electrode binder were added to a dispersion medium of N-methyl-2-pyrrolidone solution, and these were kneaded to produce a negative electrode mixture slurry. It should be noted that the mass ratio of the silicon powder and the thermoplastic polyimide was 90:10.

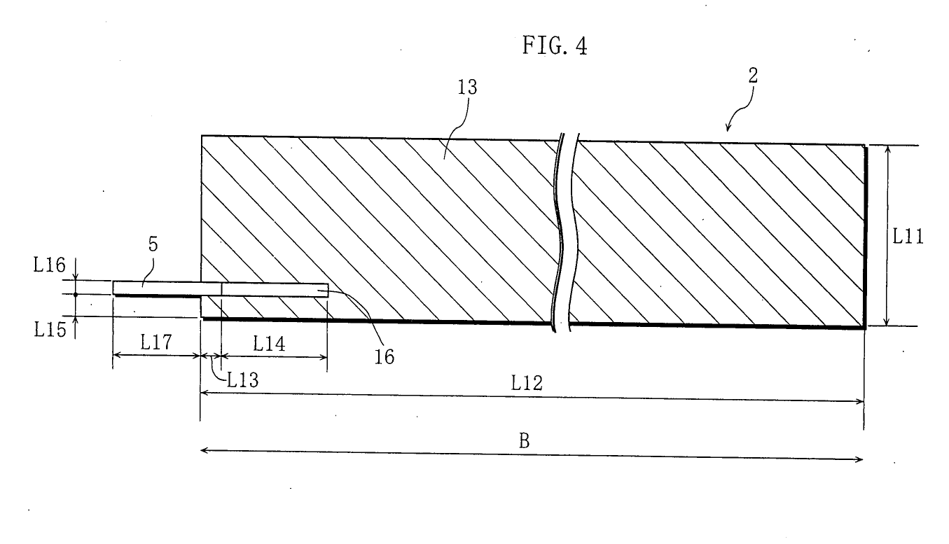

This negative electrode mixture slurry was then applied to both sides of a Cu—Zr alloy foil (thickness 25 μm, surface roughness Ra 1.0 μm, Zr content 0.03 wt %), whose faces have been made rough, serving as the negative electrode current collector, and then drying was performed to form a negative electrode mixture layer 13. It should be noted that the amount of mixture layer on the negative electrode current collector was 5.6 mg/cm². This product was then cut into a long shape (in FIG. 4, the width L11 is 52 mm and the length L12 is 390 mm) and pressure-rolled, and then was sintered by heating at 400° C. for 10 hours in an argon atmosphere.

Lastly, the negative electrode mixture layer near the negative electrode end portion was peeled off and a lengthwise long cut was formed in that portion, and the cut was bent out to form a negative electrode current collector tab 5. It should be noted that the position where the lengthwise long cut is started is a distance L13 of 5 mm from the left end and a distance L15 of 3 mm from the lower end. The lengthwise long cut has a width L16 of 4 mm and a length L14 of 15 mm. The cut was then bent up to form the negative electrode current collector tab 5. A long hole 16 was then formed in the negative electrode using the procedure discussed above. The length L17 of the negative electrode current collector tab 5 that protrudes from the end portion of the negative electrode is expressed by the length L14 of the cut minus the distance L13 from the left end, and thus is 10 mm.

### Preparation of Electrolyte Solution

First, LiPF₆ was dissolved at a ratio of 1 mol/liter in a mixed solvent obtained by mixing ethylene carbonate and diethyl carbonate at a volume ratio of 3:7, and then carbon dioxide was blown into this at 25° C. and dissolved until the mixed solvent was saturated by carbon dioxide, thus preparing a non-aqueous electrolyte solution.

### Preparation of Battery

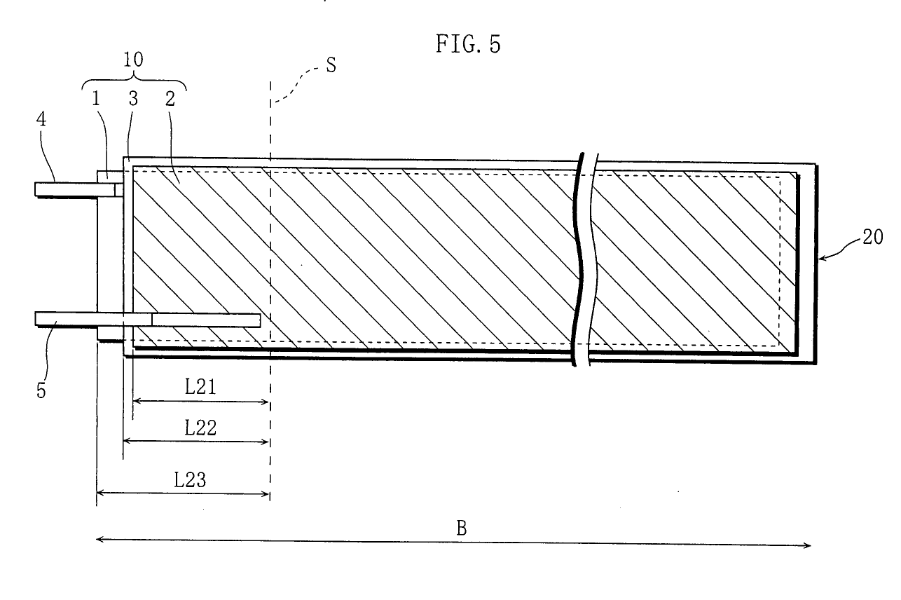

As shown in FIG. 5, a separator 3 made of porous polyethylene 22 μm, thick was sandwiched between the positive electrode 1 and the negative electrode 2, and this was bent from a winding start end 20 (the end opposite the end on the side that the current collector tabs 4 and 5 are formed) in the winding direction B at a predetermined bending position to produce a flat electrode assembly 35 mm long and 62 mm wide. It should be noted that since the flat electrode assembly is formed by this winding method, both current collectors 4 and 5 are disposed parallel to the winding direction at the outermost periphery of the flat electrode assembly. In FIG. 5, S indicates the electrode assembly outermost periphery bent position, and from the electrode assembly outermost periphery bent position S, the distance L23 to the end of the positive electrode 1 is 32 mm, the distance L22 to the end of the separator 3 is 24 mm, and the distance L21 to the end of the negative electrode 2 is 22 mm.

Lastly, the flat electrode assembly and the non-aqueous electrolyte solution were inserted and filled into a battery case, which was made of aluminum laminate, in an argon atmosphere at room temperature and atmospheric pressure, producing a lithium secondary battery.

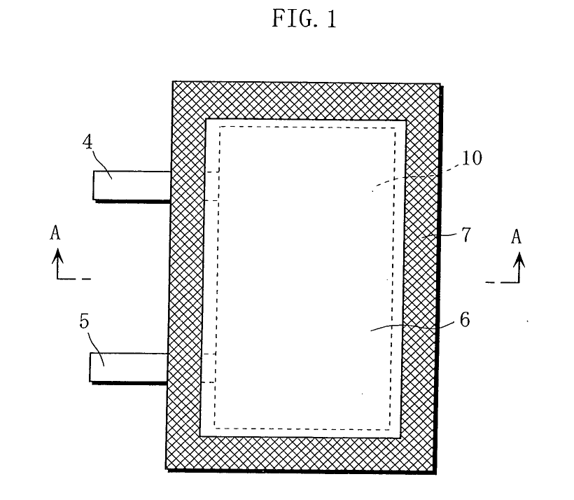

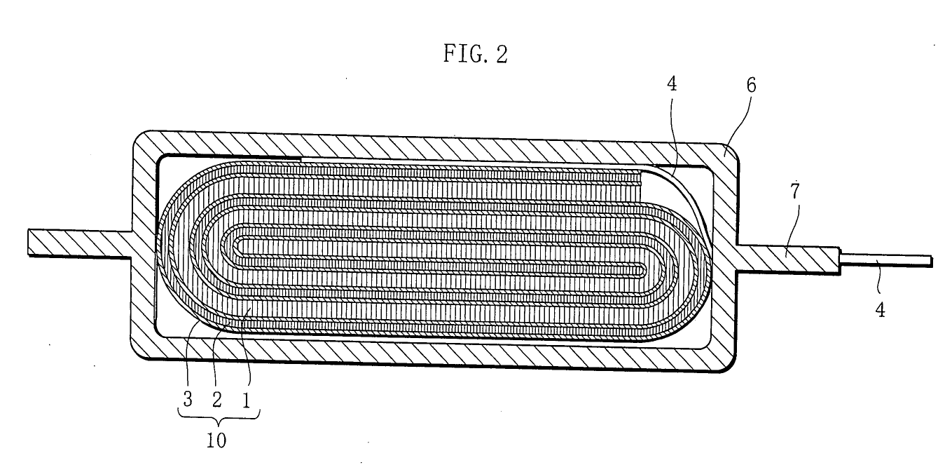

As for the specific structure of the lithium secondary battery, as shown in FIG. 1 and FIG. 2, the flat electrode assembly 10 comprising the positive electrode 1, the negative electrode 2, and the separator 3 is disposed in the accommodation space of the aluminum laminate battery case 6 provided with a sealed part 7 at which two ends of the aluminum laminate were heat sealed, and the positive electrode current collector tab 4 and the negative electrode current collector tab 5 are disposed protruding outward, producing a structure that enables charging and discharging as a secondary battery.

The battery produced in the manner discussed above is hereinafter referred to as the invention battery A1.

### EXAMPLE 2

A lithium secondary battery was prepared in the same manner as in Example 1 except that, as the current collector tabs, flat plate-shaped current collector tabs were prepared and each attached to their current collector instead of using ones obtained by bending up the current collectors.

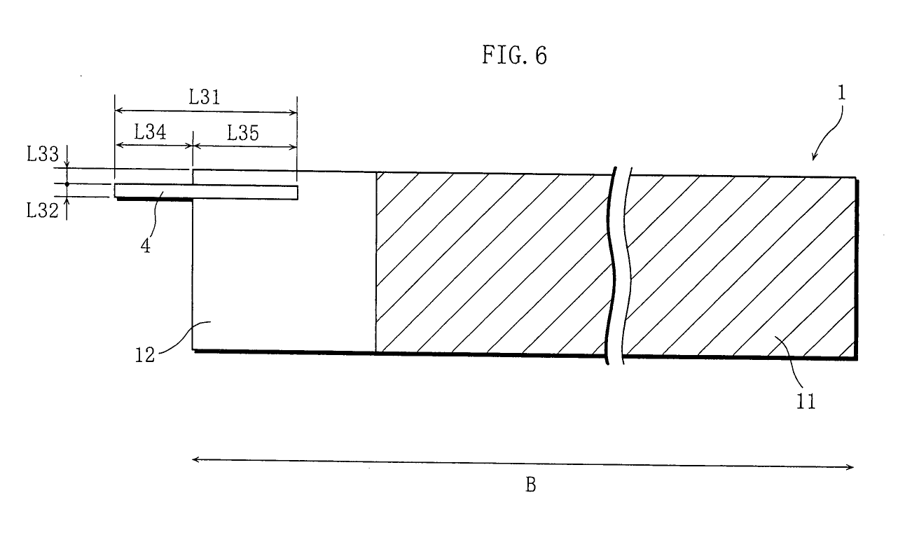

It should be noted that, as shown in FIG. 6, the positive electrode current collector tab 4 has a length L31 of 35 mm, a width L32 of 4 mm, and a thickness of 70 μm. The positive electrode current collector tab 4 is made of a thin sheet of aluminum, and is attached to the positive electrode current collector exposed portion 12 at a distance L33 of 3 mm from the upper end of the positive electrode 1 in such a manner that it is parallel to the winding direction B (lengthwise direction) of the positive electrode 1. The positive electrode current collector tab 4 is attached by ultrasonic welding, producing a structure in which the length L35 of the attached portion is 20 mm and the length L34 of the portion that protrudes beyond the positive electrode 1 is 15 mm.

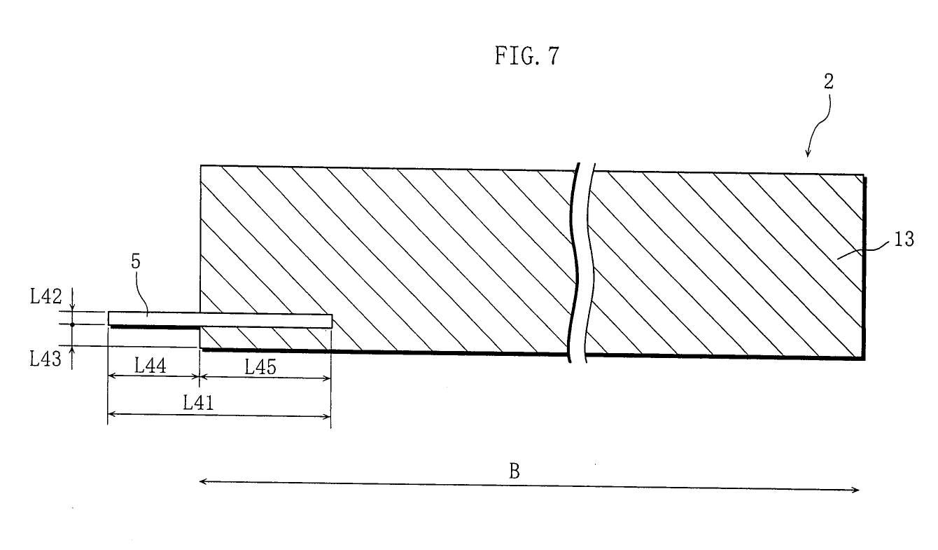

On the other hand, as shown in FIG. 7, the negative electrode current collector tab 5 has a length L41 of 35 mm, a width L42 of 4 mm, and a thickness of 70 μm. The negative electrode current collector tab 5 is made of a thin sheet of nickel, and is attached to the peeled-off portion of the negative electrode mixture layer at a distance L43 of 3 mm from the lower end of the negative electrode 2 in such a manner that it is parallel to the winding direction B (lengthwise direction) of the negative electrode 2. The negative electrode current collector tab 5 is attached by a piercing method, producing a structure in which the length L45 of the attached portion is 20 mm and the length L44 of the portion that protrudes beyond the negative electrode 2 is 15 mm.

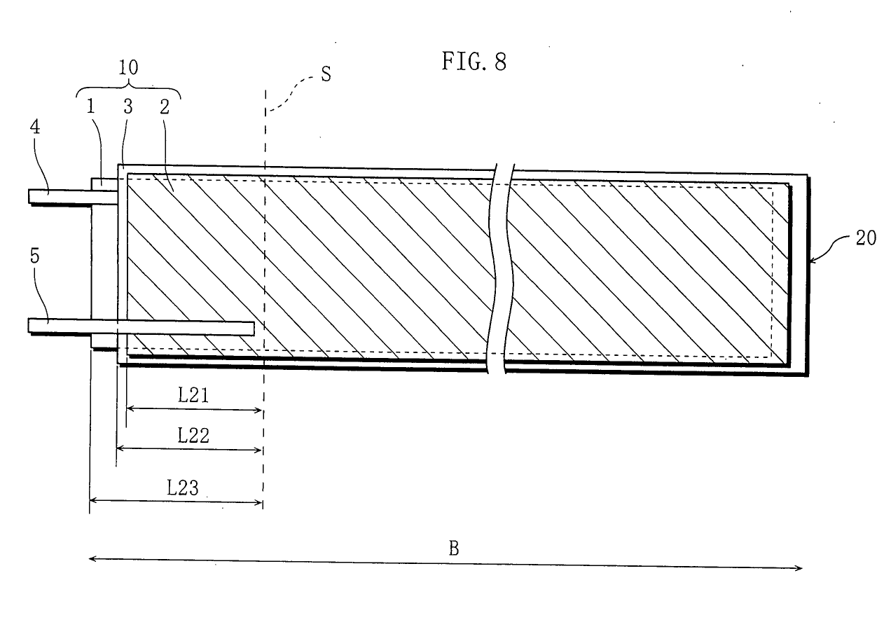

As shown in FIG. 8, from the electrode assembly outermost periphery bent position S, the distance L53 to the end of the positive electrode 1 is 31 mm, the distance L52 to the end of the separator 3 is 24 mm, and the distance L51 to the end of the negative electrode 2 is 22 mm.

The battery produced in this manner is hereinafter referred to as the invention battery A2.

### COMPARATIVE EXAMPLE 1

A lithium secondary battery was prepared in the same manner as in the Example 1 except that the two current collector tabs were provided perpendicular rather than parallel to the winding direction B (lengthwise direction) of the positive and negative electrodes.

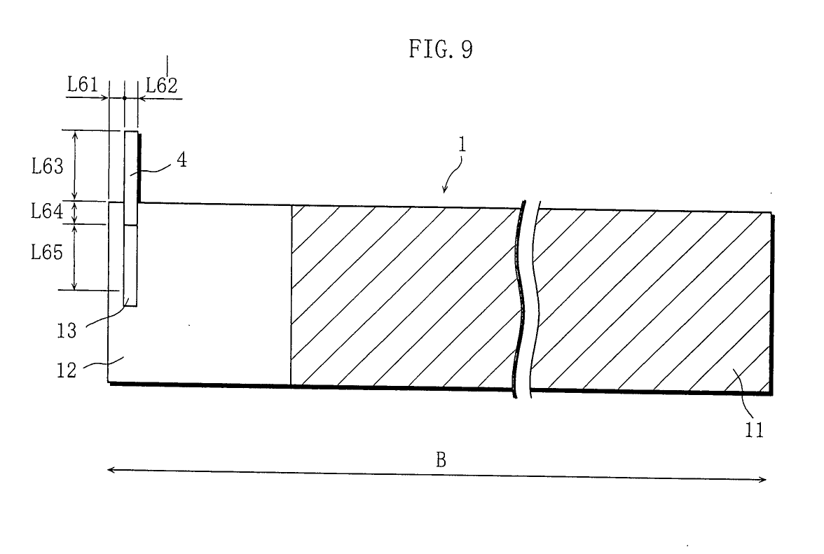

It should be noted that in regard to the method for producing the positive electrode current collector tab 4, as shown in FIG. 9, a vertically long cut (width L62 of 4 mm, length L65 of 15 mm) is provided in the positive electrode current collector exposed portion 12 at a position whose distance L61 from the left end is 3 mm and whose distance L64 from the upper end is 5 mm in such a manner that it is perpendicular to the winding direction B, and this cut is bent up to form the positive electrode current collector tab 4. It should be noted that the length L63 of the positive electrode current collector tab 4 that protrudes from the end of the positive electrode is expressed by the length L65 of the cut minus the distance L64 from the upper end, and therefore is 10 mm.

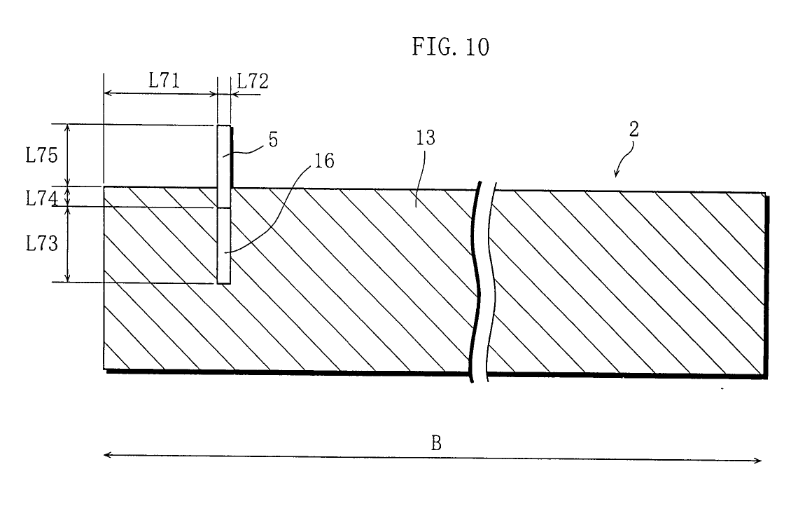

On the other hand, as shown in FIG. 10, the negative electrode current collector tab 5 is produced by peeling off the negative electrode mixture layer near the negative electrode end portion, forming the vertically long cut in that portion, and then bending out the cut area to form a negative electrode current collector tab 5. It should be noted that the position where the vertically long cut is started is a distance L71 from the left end of 15 mm and a distance L74 from the upper end of 5 mm, and the vertically long cut has a width L72 of 4 mm and a length L73 of 15 mm. After the cut is formed, the cut is bent up to form the negative electrode current collector tab 5. The long hole 16 is then formed in the negative electrode using the procedure discussed above. The length L75 of the negative electrode current collector tab 5 that protrudes from the end portion of the negative electrode is expressed by the length L73 of the cut minus the distance L74 from the upper end, and therefore is 10 mm.

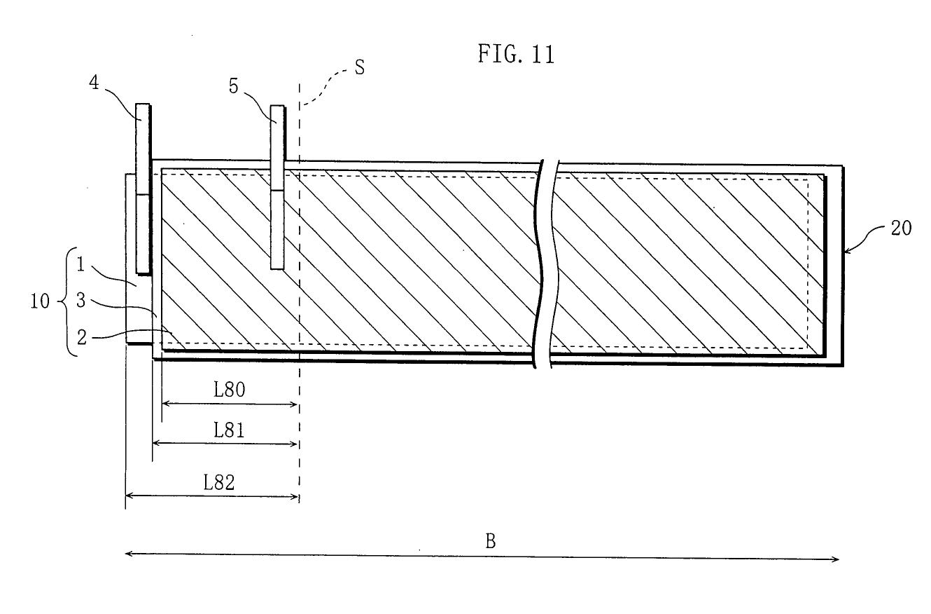

As shown in FIG. 11, from the electrode assembly outermost periphery bent position S, the distance L82 to the end of the positive electrode 1 is 32. mm, the distance L81 to the end of the separator 3 is 24 mm, and the distance L80 to the end of the negative electrode 2 is 22 mm.

The battery produced in this manner is hereinafter referred to as the comparative battery Z1. COMPARATIVE EXAMPLE 2

A lithium secondary battery was prepared in the same manner as in Comparative Example 1 except that, as the two current collector tabs, flat plate-shaped current collector tabs were prepared and each attached to a current collector instead of using ones obtained by bending the current collectors.

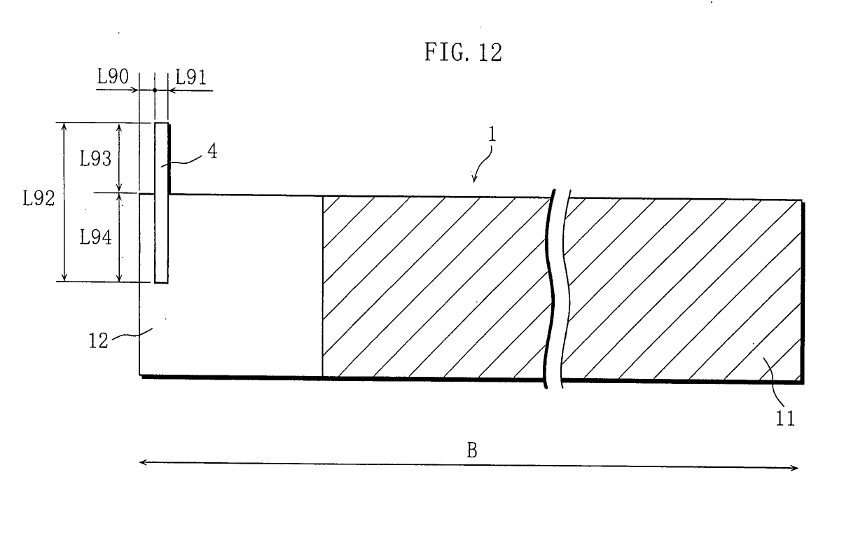

It should be noted that, as shown in FIG. 12, the positive electrode current collector tab 4 has a length L92 of 35 mm, a width L91 of 4 mm, and a thickness of 70 μm. The positive electrode current collector tab 4 is made of a thin sheet of aluminum, and is attached to the positive electrode current collector exposed portion 12 at a distance L90 of 3 mm from the left end of the positive electrode 1 in a manner that is perpendicular to the winding direction B (lengthwise direction) of the positive electrode 1. The positive electrode current collector tab 4 is attached by ultrasonic welding, producing a structure in which the length L94 of the attached portion is 20 mm and the length L93 of the portion that protrudes beyond the positive electrode 1 is 15 mm.

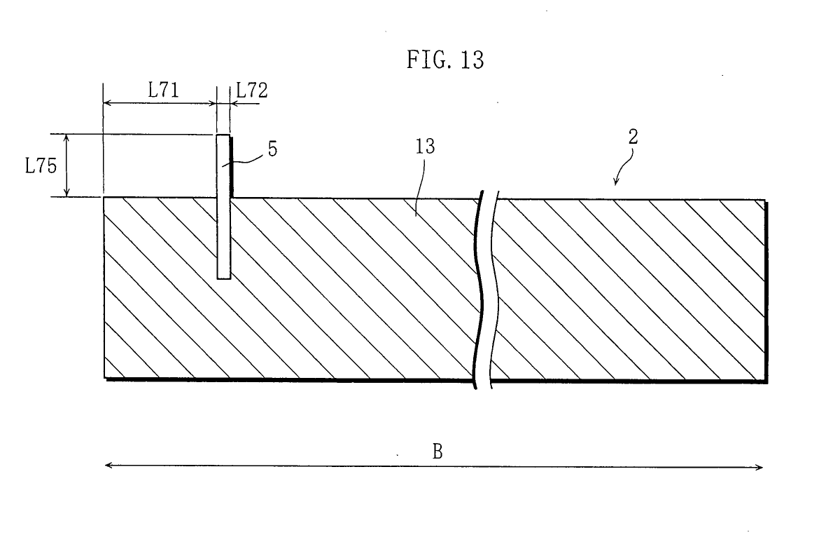

On the other hand, as shown in FIG. 13, the negative electrode current collector tab S has a length L104 of 35 mm, a width L101 of 4 mm, and a thickness of 70 μm. The negative electrode current collector tab 5 is made of a thin sheet of nickel, and is attached to the peeled-off portion of the negative electrode mixture layer at a distance L100 of 15 mm from the left end of the negative electrode 2 in such a manner that it is perpendicular to the winding direction B (lengthwise direction) of the negative electrode 2. The negative electrode current collector tab 5 is attached through a piercing method, producing a structure in which the length L103 of the attached portion is 20 mm and the length L102 of the portion that protrudes beyond the negative electrode 2 is 15 mm.

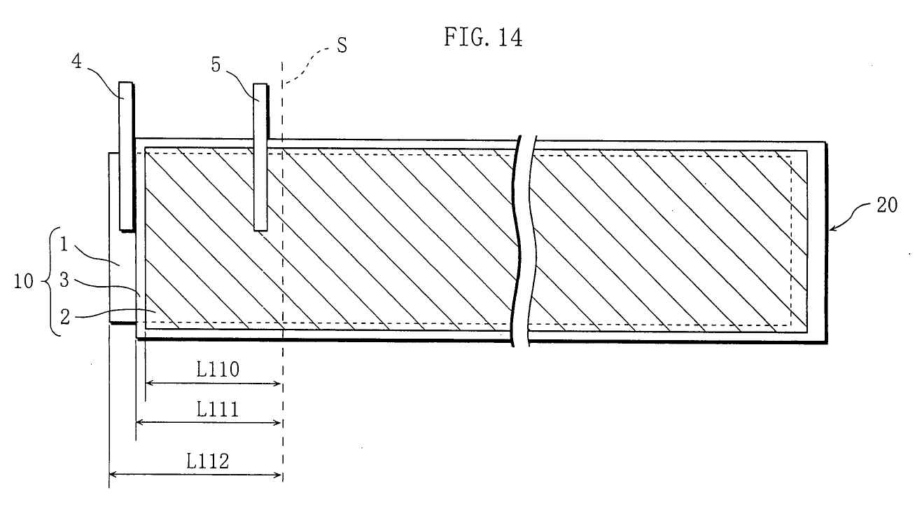

As shown in FIG. 14, from the electrode assembly outermost periphery bent position S, the distance L112 to the end of the positive electrode 1 is 32 mm, the distance L111 to the end of the separator 3 is 24 mm, and the distance L110 to the end of the negative electrode 2 is 22 mm.

The battery produced in this manner is hereinafter referred to as the comparative battery Z2.

### Experiment

The invention batteries A1 and A2, and the comparative batteries Z1 and Z2, where charged and discharged under the following charge-discharge conditions to evaluate the change in battery thickness and the charge-discharge cycle performance (cycle life), and the results are shown in Table 1.

It should be noted that the cycle life is found by measuring the number of cycles until reaching 80% of the discharge capacity of the first cycle. The cycle life of the batteries is expressed with respect to the cycle life of the invention battery A1, which is regarded as 100.

The amount of change in the battery thickness is calculated by measuring the thickness of the battery after the charge-discharge of the first cycle and after the charge-discharge of the 300th cycle, and subtracting the battery thickness after the charge-discharge of the first cycle from the battery thickness after the charge-discharge of the 300th cycle. The change in the thickness of the batteries is expressed with respect to the amount of change in the battery thickness of the invention battery A1, which is regarded as 100.

### Charge-Discharge Conditions

Charge Conditions

The battery is charged at a constant current of 200 mA to a battery voltage of 4.2 V, and is then charged at a constant voltage of 4.2 V to a current of 50 mA. The temperature is 25° C.

Discharge Conditions

The battery is discharged at a current of 200 mA to a battery voltage of 2.75 V. The temperature is 25° C.

TABLE 1

| | Tab Specifications | | | Change in Battery |
|---|---|---|---|---|
| Battery Type | Form of Tab | Tab Attachment Direction | Cycle Life | Thickness |
| Invention Battery A1 | Positive Electrode: Use Al foil current | Parallel to | 100 | 100 |
| | collector's end portion | winding direction | | |
| | Negative Electrode: Use Cu foil current | | | |
| | collector end portion | | | |
| Invention Battery A2 | Positive Electrode: Use separate Al sheet | Parallel to | 102 | 44 |
| | Negative Electrode: Use separate Ni sheet | winding direction | | |
| Comparative Battery X1 | Positive Electrode: Use Al foil current | Perpendicular to | 101 | 120 |
| | collector's end portion | winding direction | | |
| | Negative Electrode: Use Cu foil current | | | |
| | collector's end portion | | | |
| Comparative Battery X2 | Positive Electrode: Use separate Al sheet | Perpendicular to | 99 | 172 |
| | Negative Electrode: Use separate Ni sheet | winding direction | | |

It is clear from Table 1 that the invention batteries A1 and A2, in which the current collector tabs provided for the positive and negative electrodes in the outermost periphery portion of the electrode assembly are formed parallel to the winding direction, have substantially the same cycle life as the comparative batteries Z1 and Z2, in which the current collector tabs are formed perpendicular to the winding direction, while they experience a smaller increase in battery thickness after the charge-discharge cycle. Consequently, it can be understood that lithium secondary batteries provided with the structure of the invention are high energy density and can obtain excellent charge-discharge cycle performance.

The reason for this is that by forming current collector tabs that are parallel to the winding direction of the electrode assembly for both the positive electrode and the negative electrode, it is possible to prevent the current collector tabs, which are in the interior of the battery, from deforming toward the center of the electrode assembly even if the negative electrode mixture layer expands in volume and causes both bent portions of the electrode assembly to bulge toward the center of the electrode assembly. Consequently, there is no attempt by the current collector tabs to twist, and therefore the presence of the current collector tabs can keep bending of the electrode assembly from being exacerbated further.

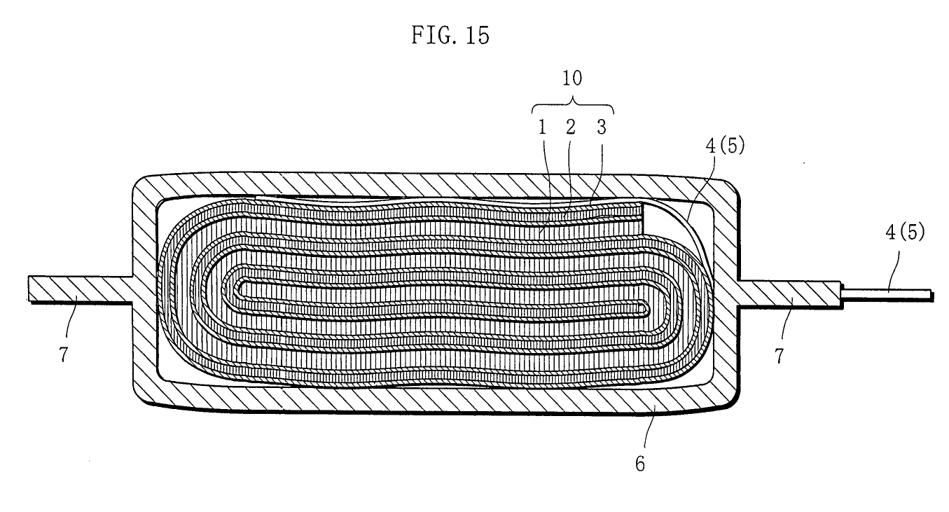

Comparing the invention battery A1 and the invention battery A2, it can be understood that even though the current collector tabs in both cases are formed parallel to the winding direction of the electrode assembly, the increase in the battery thickness after the charge-discharge cycle is significantly reduced in the invention battery A2, in which current collector tabs that are separate from the two current collectors are attached onto the current collector, compared to the invention battery A1, in which the two current collectors are bent up to form the current collector tabs (this state is shown in FIG. 15).

A likely reason for this is that the mechanical strength of the current collectors 4 and 5 that follows from attaching the current collector tabs 4 and 5 parallel to the winding direction of the electrode assembly 10 and attaching current collector tabs 4 and 5 that are different from the current collectors as shown in FIG. 15, has the effect of inhibiting the wavelike bending in the electrode assembly 10 that occurs when charging and discharging.

### Other Embodiments

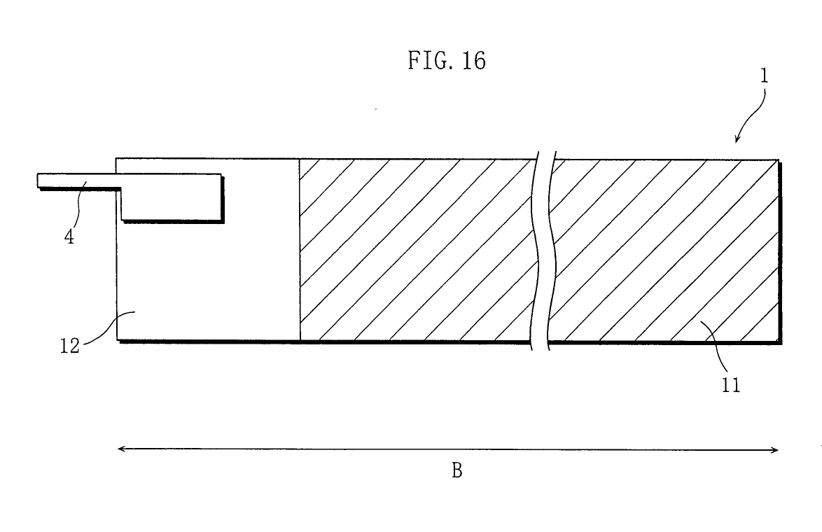

(1) In the foregoing examples, the width of the current collector tabs is uniform when flat plate-shaped current collector tabs are attached to a current collector, but there is no limitation to this structure. For example, using the positive electrode current collector tab as an example, it is of course also possible to adopt a configuration in which the width of the portion that is attached to the positive electrode current collector exposed portion 12 is increased, as shown in FIG. 16.

(2) In the forgoing examples, both current collector tabs are provided parallel to the winding direction, but it is sufficient for at least one of the current collector tabs to be provided parallel to the winding direction.

(3) Variations of the Positive Electrode

(a) A lithium-transition metal composite oxide is preferable as the positive electrode active material in the lithium secondary battery of the invention. Examples of a lithium-transition metal composite oxide include LiCoO₂, LiNiO₂, LiMn₂O₄, LiMnO₂, LiCo_{0.5}Ni_{0.5}O₂, LiNi_{0.33}Co_{0.33}Mn_{0.34}O₂, and it is particularly preferable to use LiCoO₂ and a lithium-transition metal composite oxide that has a layered structure containing Li, Ni, Mn, and Co.

(b) It is preferable that the BET specific surface area of the lithium-transition metal composite oxide be 3 m²/g or less. This is because the contact area with the non-aqueous electrolyte is too large when the BET specific surface area of the lithium-transition metal composite oxide exceeds 3 m²/g, and as a result the reactivity with the non-aqueous electrolyte increases, and this increases the likelihood of side reactions, such as the production of gas due to decomposition of the non-aqueous electrolyte, and thus lowers the charge-discharge characteristics.

(c) It is preferable that the average particle size of the lithium-transition metal composite oxide (average particle size of the secondary particles) be not more than 20 μm. This is because an average particle size greater than 20 μm causes the distance diffused by lithium in the lithium-transition metal composite oxide particles to become large and thus lowers the charge-discharge cycle performance.

(d) In the positive electrode of the lithium secondary battery of the invention, it is preferable that the positive electrode mixture layer include the positive electrode conductive agent. Various conductive agents that are known to the public may be used as the positive electrode conductive agent, and for example, a carbon material that is conductive can be preferably used, and in particular, acetylene black or Ketjen Black can be preferably used.

It is preferable that the positive electrode conductive agent account for at least 1 wt % but not more than 5 wt % of the total weight of the positive electrode mixture layer. This is because the quantity of conductive agent is too little when it accounts for less than 1 wt % of the total weight of the positive electrode mixture layer, and as a result, a sufficient conductive network is not formed around the positive electrode active material, lowering the current collection performance in the positive electrode mixture layer and lowering the charge-discharge characteristics. On the other hand, the quantity of conductive agent is too great when it accounts for more than 5 wt % of the total weight of the positive electrode mixture layer, and as a result, the binder is used to adhere the conductive agent, and this lowers the tightness of the binding between the positive electrode active agent particles and between the positive electrode active material and the positive electrode current collector, increasing the likelihood that the positive electrode active material will peel off and consequently lowering the charge-discharge characteristics.

(e) There are no particular limitations regarding the use of various binders that are known to the public as the positive electrode binder, as long as the binder does not dissolve in the solvent for the non-aqueous electrolyte of the invention, and for example, it is possible to preferably use a fluororesin such as polyvinylidene fluoride, a polyimide-based resin, or a polyacrylonitrile.

It is preferable that the positive electrode binder account for at least 1 wt % but not more than 5 wt % of the total weight of the positive electrode mixture layer. This is because when the positive electrode binder accounts for less than 1 wt % of the total weight of the positive electrode mixture layer, the contact area between the particles of the positive electrode active agent increases and the contact resistance drops, however since the amount of positive electrode binder is too small, the tightness of the binding between the positive electrode active agent particles and between the positive electrode active material and the positive electrode current collector drops, increasing the likelihood that the positive electrode active material will peel off and consequently lowering the charge-discharge characteristics. On the other hand, when the positive electrode binder accounts for greater than 5 wt % of the total weight of the positive electrode mixture layer, the ability of the positive electrode active material particles to tightly adhere to one another and the ability of the positive electrode active material to tightly adhere to the positive electrode current collector improves, however, the amount of positive electrode binder is too great and thus the contact area between the positive electrode active material particles becomes smaller and the contact resistance increases, lowering the charge-discharge characteristics.

(f) It is preferable that the density of the positive electrode mixture layer be at least 3.0 g/cm³. This is because if the density of the positive electrode mixture layer is at least 3.0 g/cm³, then the contact area between the positive electrode active material particles is increased and this improves the current collection performance in the positive electrode mixture layer, and thus excellent charge-discharge characteristics can be obtained.

(4) Variations of the Negative Electrode

(a) It is preferable that the negative electrode binder have a high mechanical strength and excellent elasticity. The reason for this is that by giving the binder excellent mechanical properties, the negative electrode mixture layer can change shape as the volume of the silicon active material changes without destruction of the binder occurring, even when the volume of the silicon negative electrode active material changes when lithium is occluded and released, and thus the current collection performance in the electrode are retained and it is possible to obtain excellent charge-discharge cycle performance. A polyimide resin can be favorably used as a binder having high mechanical properties. It is also possible to favorably use a fluororesin such as polyvinylidene fluoride or polytetrafluoroethylene.

(b) In a case where the negative electrode is fabricated by sintering, it is particularly preferable that the negative electrode binder be thermoplastic. For example, in a case where the negative electrode binder has a glass transition temperature or melting point, by performing thermal processing for sintering the negative electrode mixture layer onto the surface of the negative electrode current collector at a higher temperature than its glass transition temperature or melting point, the binder is thermally fused to the negative electrode active material particles or the negative electrode current collector and this further significantly increases the tightness of the bond between the negative electrode active material particles and between the negative electrode mixture layer and the negative electrode current collector. As a result, the current collection performance in the electrode is significantly improved and it becomes possible to obtain even better charge-discharge cycle performance.

It should be noted that in this case, it is preferable that the negative electrode binder be not completely decomposed and some of it remain even after the thermal processing for sintering the negative electrode mixture layer onto the negative electrode current collector surface. This is because if the binder is completely decomposed after the thermal processing, then the effect of binding due to the binder is lost, and thus there is a significant drop in the current collection performance within the electrode and poor charge-discharge cycle performance is the result.

(c) It is preferable that the negative electrode binder account for at least 5% but not more than 50% of the total mass of the negative electrode mixture layer, and that the volume taken up by the negative electrode binder be at least 5% but not more than 50% of the total volume of the negative electrode mixture layer. The reason for this is that if the negative electrode binder makes up less than 5% of the total mass of the mixture layer or the volume taken up by the negative electrode binder is less than 5% of the total volume of the mixture layer, then there is too little negative electrode binder for the negative electrode active material particles and thus the binding in the electrode due to the negative electrode binder is not sufficient, whereas when the negative electrode binder makes up more than 50% of the total mass of the mixture layer or the volume taken up by the negative electrode binder is more than 50% of the total volume of the mixture layer, the resistance in the electrode increases and thus the initial charging becomes difficult. It should be noted that the total volume of the negative electrode mixture layer is the sum of the volume of the materials for the negative electrode active material and the negative electrode binder, for example, in the negative electrode mixture layer, and does not include the volume of the gaps that may be present in the negative electrode mixture layer.

(d) There are no particular limitations regarding the average particle size of the negative electrode active material particles in the lithium secondary battery of the invention, but preferably this is not more than 100 μm, more preferably not more than 50 μm, and most preferably not more than 15 μm. This is because if active material with a small particle size is used, then the absolute amount of the expansion and shrinkage of the volume of the active material particles that accompanies the occlusion and release of lithium when charging and discharging becomes small, and thus the absolute amount of the strain between the active material particles in the electrode during charging and discharging also becomes small. Thus, the negative electrode binder becomes less likely to break and a drop in the current collection performance in the electrode can be inhibited, and as a result, it is possible to obtain excellent charge-discharge cycle performance.

(e) It is preferable that the particle size distribution of the negative electrode active material particles in the lithium secondary battery of the invention be as narrow as possible. This is because when the particle size distribution is wide, between negative electrode active material particles with significantly difference particles sizes there will be a large difference in the absolute amount of expansion and shrinkage of the volume that accompanies the occlusion and release of lithium, and this causes strain within the negative electrode mixture layer. Thus, destruction of the binder occurs and lowers the current collection performance in the electrode, leading to a drop in the charge-discharge cycle performance.

(f) It is preferable that the surface roughness Ra of the face of the conductive metal foil serving as the negative electrode current collector on which the negative electrode mixture layer is disposed be at least 0.2 μm. Using a conductive metal film that has such a surface roughness Ra as the negative electrode current collector allows the negative electrode binder to enter into the areas of the negative electrode current collector where the surface is irregular and has the effect of anchoring the negative electrode binder and the negative electrode current collector, and thus a high degree of intimate contact is obtained. As a result, peeling of the negative electrode mixture layer from the negative electrode current collector due to the expansion and shrinkage of the volume of the active material particles that accompanies lithium occlusion and release is inhibited. It should be noted that if the negative electrode mixture layer is disposed on both sides of the negative electrode current collector, then it is preferable that both surfaces of the negative electrode current collector have a surface roughness Ra of at least 0.2 μm.

To achieve a surface roughness Ra of 0.2 μm or more, a roughening process can be performed on the conductive metal foil, and examples of such a roughening process include plating, vapor deposition, etching, and polishing. Plating and vapor deposition are techniques for roughening a surface by forming a thin film layer having irregularities on the surface of a metal foil. Examples of plating include electroplating and electroless plating, and examples of vapor deposition include sputtering, chemical vapor deposition, and evaporation. Examples of etching include physical etching and chemical etching methods, and examples of polishing include polishing with sandpaper and polishing by blasting.

It is preferable that the relationship between the above surface roughness Ra and the mean profile peak spacing S be 100 Ra≧S. The surface roughness Ra and the mean profile peak spacing S are determined according to Japanese Industrial Standards (JIS B 0601-1994), and are measured by a surface roughness meter, for example.

Examples of the negative electrode current collector include foils of metals such as copper, nickel, iron, titanium, and cobalt, and foils of alloys made of a combination of these metals.

(g) It is particularly preferable that the negative electrode current collector have a high mechanical strength. The reason for this is that by giving the negative electrode current collector a high mechanical strength, the stress that is caused by the change in volume of the negative electrode active material, which contains silicon, during lithium occlusion and release and that is applied to the negative electrode current collector can be lessened, without breaking or plastically deforming the negative electrode current collector. Thus, peeling of the negative electrode mixture layer from the negative electrode current collector is inhibited, the current collection performance in the negative electrode is maintained, and excellent charge-discharge performance can be obtained.

(h) There are no particular limitations regarding the thickness of the negative electrode current collector made of the conductive metal foil, but preferably it is in the range of 10 μm to 100 μm.

There is no particular upper limit to the surface roughness Ra of the negative electrode current collector, but as mentioned above, it is preferable that the thickness of the negative electrode current collector be in the range of 10 μm to 100 μm, and thus in practical terms the upper limit of the surface roughness Ra is 10 μm or less.

(i) In the negative electrode, if the thickness of the negative electrode mixture layer is X and the thickness of the negative electrode current collector is Y, then relationship between the thickness X of the negative electrode mixture layer, the thickness Y of the negative electrode current collector, and the surface roughness Ra is 5Y≧X and 250 Ra≧X. This is because if the thickness X of the negative electrode mixture layer exceeds 5Y or 250 Ra, then the expansion and shrinkage in the volume of the negative electrode mixture layer at the time of charging and discharging is large and as a result, depending on the irregularities in the negative electrode current collector surface, the close adherence between the negative electrode mixture layer and the negative electrode current collector will be lost and the negative electrode mixture layer will peel from the negative electrode current collector.

It should be noted that there are no particular limitations regarding the thickness X of the negative electrode mixture layer, but preferably it is not more than 1000 μm, and more preferably 10 μm to 100 μm.

(j) In the negative electrode of the invention, it is also possible to mix negative electrode conductive powder into the negative electrode mixture layer. This is because mixing in negative electrode conductive powder results in the formation of a conductive network around the negative electrode active material particles due to the negative electrode conductive powder, and as a result the current collection performance of the electrode can be improved further. As the negative electrode conductive powder, the same material as the negative electrode current collector, which is made of a conductive metal foil, can be favorably used. Specifically, a metal such as copper, nickel, iron, titanium, or cobalt, or an alloy or mixture made of a combination of these is possible, and in copper powder is particularly preferably used. Conductive carbon powder also can be preferably used.

As for the amount of negative electrode conductive powder that is mixed in, it is preferable that the mass of the negative electrode conductive powder be not more than 50% of the total mass of the negative electrode active material and the negative electrode conductive powder, and that the volume of the conductive powder is not more than 20% of the total volume of the negative electrode mixture layer. This is because when too much negative electrode conductive powder is mixed in, the proportion of the negative electrode active material in the negative electrode mixture layer becomes relatively small, and thus the charge-discharge capacity of the negative electrode becomes small and there is a drop in the ratio of the negative electrode binder amount to the total amount of the negative electrode active material and the negative electrode conductive agent in the negative electrode mixture layer, and as a result, there is a drop in the strength of the negative electrode mixture layer and a drop in the charge-discharge cycle performance.

It should be noted that there are no particular limitations regarding the average particle size of the negative electrode conductive powder, but preferably is 100 μm or less, more preferably 50 μm or less, and most preferably 10 μm or less.

(5) Variations of the Non-Aqueous Electrolyte

(a) There are no particular limitations regarding the solvent for the non-aqueous electrolyte, and it is possible to use a cyclic carbonate such as ethylene carbonate, propylene carbonate, butylene carbonate, or vinylene carbonate, a chain carbonate such as dimethyl carbonate, methyl ethyl carbonate, or diethyl carbonate, an ester such as methyl acetate, ethyl acetate, propyl acetate, methyl propionate, ethyl propionate, or γ-butyrolactone, an ether such as 1,2-dimetoxyethane, 1,2-diethoxyethane, tetrahydrofuran, 1,2-dioxane, or 2-methyltetrahydrofuran, a nitrile such as acetonitrile, and an amide such as dimethylformamide, and it is possible to use these alone or to use a plurality of these in combination. In particular, a mixed solvent of a cyclic carbonate and a chain carbonate can be favorably used.

(b) There are no particular limitations regarding the solute for the non-aqueous electrolyte, and it is possible to use a compound that is expressed by the chemical formula LiXF_{y} (where X is P, As, Sb, B, Bi, Al, Ga, or In, and y is 6 when X is P, As, or Sb, and y is 4 when X is B, Bi, Al, Ga, or In) such as LiPF₆, LiBF₄, or LiAsF₆, or a lithium compound such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiClO₄, Li₂B₁₀Cl₁₀, or Li₂B₁₂Cl₁₂. Of these, LiPF₆ can be used particularly preferably.

(c) The non-aqueous electrolyte of the invention preferably contains dissolved carbon dioxide. This is because dissolving carbon dioxide into the non-aqueous electrolyte causes the lithium occlusion and release reactions on the surfaces of the positive electrode active material and the negative electrode active material to occur smoothly and to thus attain even better charge-discharge performance.

(d) Examples of the non-aqueous electrolyte include gelled polymer electrolytes in which an electrolyte solution is impregnated in a polymer electrolyte such as polyethylene oxide or polyacrylonitrile, and inorganic solid electrolytes such as LiI and Li₃N. The non-aqueous electrolyte of the invention can be used without restriction as long as the lithium compound that functions as a solute that achieves lithium ion conductivity, and the solvent that dissolves and holds this solute, are not decomposed when charging and discharging the battery or while stored.

The invention can be adopted not only in the driving power source of mobile information terminals such as portable telephones, notebook computers, or PDAs, but also in large-scale batteries such as the in-vehicle power sources of electric automobiles and hybrid automobiles.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A lithium secondary battery comprising:
a sheet-shaped positive electrode in which a positive electrode mixture layer containing a positive electrode active material is disposed on a surface of a positive electrode current collector made from a conductive metal foil;
a sheet-shaped negative electrode in which a negative electrode mixture layer containing negative electrode active material particles and a negative electrode binder for binding the negative electrode active material particles to one another is disposed on a surface of a negative electrode current collector made from a conductive metal foil;
a sheet-shaped separator that is disposed between the positive electrode and the negative electrode;
a non-aqueous electrolyte; and
a battery case accommodating a flat electrode assembly in which the positive electrode and the negative electrode are wound in a state where they are in opposition to one another across the separator,
wherein: the negative electrode active material contains silicon; and at least one of the current collectors, of the positive electrode current collector at the outermost periphery portion of the flat electrode assembly and the negative electrode current collector at the outermost periphery portion of the flat electrode assembly, is provided with a current collector tab that is parallel to the winding direction of the flat electrode assembly.

2. The lithium secondary battery according to claim 1, wherein both the positive electrode current collector and the negative electrode current collector have a current collector tab provided parallel to the winding direction of the flat electrode assembly.

3. The lithium secondary battery according to claim 1, wherein the negative electrode mixture layer is disposed sintered on the surface of the negative electrode current collector.

4. The lithium secondary battery according to claim 2, wherein the negative electrode mixture layer is sintered and disposed on the surface of the negative electrode current collector.

5. The lithium secondary battery according to claim 1, wherein a positive electrode current collector tab that is separate from the positive electrode current collector is attached to the positive electrode current collector, and a negative electrode current collector tab that is separate from the negative electrode current collector is attached to the negative electrode current collector.

6. The lithium secondary battery according to claim 2, wherein a positive electrode current collector tab that is separate from the positive electrode current collector is attached to the positive electrode current collector, and a negative electrode current collector tab that is separate from the negative electrode current collector is attached to the negative electrode current collector.

7. The lithium secondary battery according to claim 5, wherein the positive electrode current collector tab is made from a flat aluminum sheet, and the negative electrode current collector tab is made from a flat nickel sheet.

8. The lithium secondary battery according to claim 6, wherein the positive electrode current collector tab is made from a flat aluminum sheet, and the negative electrode current collector tab is made from a flat nickel sheet.

9. The lithium secondary battery according to claim 7, wherein the aluminum sheet and the nickel sheet are both at least 50 μm thick but not more than 100 μm thick.

10. The lithium secondary battery according to claim 8, wherein the aluminum sheet and the nickel sheet are both at least 50 μm thick but not more than 100 μm thick.

11. The lithium secondary battery according to claim 5, wherein a proportion of the attached area of the positive electrode current collector tab with respect to the electrode area of the planar portion of the positive electrode that is located at the outermost periphery of the flat electrode assembly, and/or a proportion of the attached area of the negative electrode current collector tab with respect to the electrode area of the planar portion of the negative electrode that is located at the outermost periphery of the flat electrode assembly, is regulated so that it is 5% or more.

12. The lithium secondary battery according to claim 6, wherein a proportion of the attached area of the positive electrode current collector tab with respect to the electrode area of the planar portion of the positive electrode that is located at the outermost periphery of the flat electrode assembly, and/or a proportion of the attached area of the negative electrode current collector tab with respect to the electrode area of the planar portion of the negative electrode that is located at the outermost periphery of the flat electrode assembly, is regulated so that it is 5% or more.

13. A method of producing a lithium secondary battery, comprising:
fabricating a positive electrode by disposing a positive electrode mixture layer containing positive electrode active material particles and a positive electrode binder on a surface of a positive electrode current collector made from a sheet-shaped conductive metal foil, and fabricating a negative electrode by disposing a negative electrode mixture layer containing negative electrode active material particles and a negative electrode binder on a surface of a negative electrode current collector made from a sheet-shaped conductive metal foil;
forming a positive electrode current collector tab, made of a metal material, near one end portion of the positive electrode and parallel to a lengthwise direction of the positive electrode, and forming a negative electrode current collector tab, made of a metal material, near one end portion of the negative electrode and parallel to a lengthwise direction of the negative electrode;
winding the positive electrode and the negative electrode parallel to the direction in which the current collector tabs are attached, in a state where the positive electrode and the negative electrode in opposition to one another across a separator, to produce a flat electrode assembly in which the two current collector tabs are exposed from the outermost periphery; and
accommodating the flat electrode assembly in a battery case and filling an electrolyte solution into the battery case.

14. The method according to claim 13, wherein the negative electrode active material contains silicon, and when fabricating the negative electrode in the step of fabricating the positive and the negative electrodes, the negative electrode mixture layer containing negative electrode active material particles and a negative electrode binder is sintered on the surface of the negative electrode current collector.
